(19) United States
(12) Patent Application Publication
(10) Pub. No.: US 2008/0189377 A1
(43) Pub. Date: Aug. 7, 2008

(54) SYSTEM FOR TRANSMITTING AND RECEIVING AN ELECTRONIC MAIL

(75) Inventor: Yasuhiko Wakabayashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/060,665

(22) Filed: Apr. 1, 2008

Related U.S. Application Data
(62) Division of application No. 10/899,151, filed on Jul. 27, 2004.

(30) Foreign Application Priority Data
Jul. 30, 2003 (JP) 283145/2003

(51) Int. Cl. G06F 15/16

(52) U.S. Cl. 709/206

(57) ABSTRACT

An electronic mail system comprises a transmitting terminal which transmits an electronic mail, a server which receives the electronic mail from the transmitting terminal, retrieves a specific data relating to the electronic mail from at least one of a network coupled to the sever and an internal memory of the sever, transmits at least one of the specific data and an item list of the specific data, and transmits the electronic mail, and a receiving terminal which receives at least one of the specific data and the item list of the specific data from the server, receives the electronic mail from the server, and displays at least one of the specific data and the item of the specific data.

### BACKGROUND OF THE INVENTION

The present invention relates to a system for transmitting and receiving an electronic mail.

In the Internet rapidly coming into widespread recently, there exists enormous amount of information. Therefore, it is difficult and time-consuming to find out desired information out of such a large amount of information. In the Internet, a website that is called a search engine (search site) is provided. When a user conducts a search using such a conventional web site of search engine, the user opens the web site by the World Wide Web (WWW) browser, and inputs a word and the like as a keyword for the search. Accordingly, the search engine conducts a search using the word and the like thus inputted as a keyword, and transmits a result of the search to the WWW browser.

The WWW browser displays a web site showing a result of the search transmitted from the search engine. Therefore, it is necessary for the user to open the search engine every time when he or she conducts a search. Further in each case, the user is also required to request a search by inputting a word and the like as a search keyword.

A search system in the Internet as disclosed in the Japanese Patent Laid-open Publication No. 2000-305951 utilizes a general search engine. However, for the user who is not accustomed to such a search system, it is difficult to utilize even a simple searching function, to say nothing of a multifunctional searching such as AND/OR. It is also difficult for such unaccustomed user to retrieve a suitable and appropriate amount of search result. In view of this problem, the Japanese Patent Laid-open Publication No. 2000-305951 discloses that an identical matching card (guidance page) between a side requesting a search and a side executing the search is used, whereby simple and optimum search can be conducted.

The Japanese Patent Laid-open Publication No. 2001-306570 discloses that database access is available only with an E-mail function, and even on the road or in transit it is possible to access the database by a mobile phone or a portable terminal.

The Japanese Patent Laid-open Publication No. 2000-285045 discloses a system for searching information on the Internet by use of E-mail. In this system, an alternate search server which has received an E-mail from a mobile phone makes a search request to a search site, using descriptive contents in the E-mail as a keyword. Furthermore, the alternate search sever returns a search result to the mobile phone which has sent the E-mail.

The Japanese Patent Laid-open Publication No. 2003-76711 discloses an information search system which is easy to use, even a user does not have sufficient knowledge how to use a browser or about inputting rules. When a terminal transmits an E-mail to a designated mail address for executing a search, this system automatically extracts a necessary keyword and conducts a search. In addition, this system combines information from an advertising database and information from a search processing device into one electronic mail, and converts it into a text format available for browsing. Furthermore, this system returns a result of the search to its own terminal which has transmitted the E-mail. In other words, one particular system handles both the side requesting a search and the side receiving the search result.

The Japanese Patent Laid-open Publication No. 2000-353132 discloses an E-mail FAX server which is capable of carrying out effective translation works.

At the current stage, there has not been provided any favorable system which allows a receiving side user to retrieve a mail transmitted from a sending side user, together with information relating to the mail.

### SUMMARY OF THE INVENTION

An electronic mail system comprises a transmitting terminal which transmits an electronic mail, a server which receives the electronic mail from the transmitting terminal, retrieves a specific data relating to the electronic mail from at least one of a network coupled to the sever and an internal memory of the sever, transmits at least one of the specific data and an item list of the specific data, and transmits the electronic mail, and a receiving terminal which receives at least one of the specific data and the item list of the specific data from the server, receives the electronic mail from the server, and displays at least one of the specific data and the item of the specific data.

### BRIEF DESCRIPTION OF THE DRAWINGS

FIG. 1 is a configuration diagram showing a first embodiment of the electronic mail transmitting and receiving system according to the present invention.

FIG. 2 is a block diagram showing a configuration of the server 21 in the first embodiment of the electronic mail transmitting and receiving system according to the present invention.

FIG. 3 is a block diagram showing a configuration of the receiving terminal 23 in the first embodiment of the electronic mail transmitting and receiving system according to the present invention.

FIG. 4 is a flowchart showing an operation of the server 21 in the first embodiment of the electronic mail transmitting and receiving system according to the present invention.

FIG. 5 is a flowchart showing an operation of the receiving terminal 23 in the first embodiment of the electronic mail transmitting and receiving system according to the present invention.

FIG. 6 is a configuration diagram showing an second embodiment of the electronic mail transmitting and receiving system according to the present invention.

FIG. 7 is a configuration diagram showing the mail sever 2a or 2b in the second embodiment of the electronic mail transmitting and receiving system according to the present invention.

FIG. 8 is a view of a table in the information database 8 within the mail servers 2a or 2b in the second embodiment of the electronic mail transmitting and receiving system according to the present invention.

FIG. 9 is a block diagram showing a configuration of the terminal 1a or 1b in the second embodiment of the electronic mail transmitting and receiving system according to the present invention.

FIG. 10 is a flowchart showing an operation of transmitting mail server 2a in the second embodiment of the electronic mail transmitting and receiving system according to the present invention.

FIG. 11 is a flowchart showing an operation of receiving mail server 2b in a second embodiment of the electronic mail transmitting and receiving system according to the present invention.

FIG. 12 is a flowchart showing an operation of receiving terminal in a second embodiment of the electronic mail transmitting and receiving system according to the present invention.

FIG. 13 is a display view at the receiving terminal 1b in the second embodiment of the electronic mail transmitting and receiving system according to the present invention.

### DETAILED DESCRIPTION

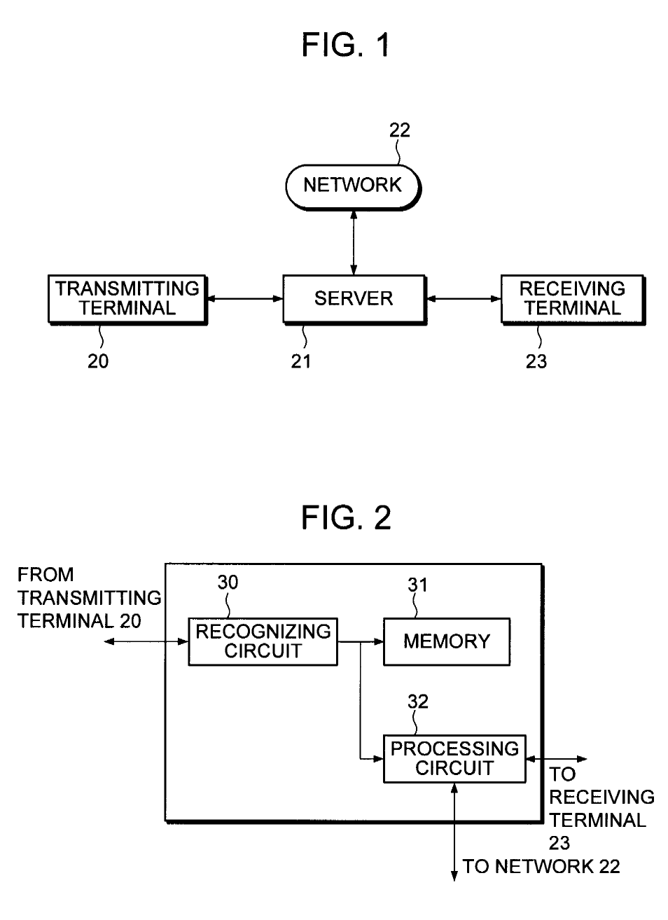

FIG. 1 is a configuration diagram showing a first embodiment of the electronic mail transmitting and receiving system according to the present invention. As shown in FIG. 1, the electronic mail transmitting and receiving system according to the invention comprises a transmitting terminal 20, a server 21, a network 22, and a receiving terminal 23.

The transmitting terminal 20 transmits an electronic mail to the server 21. Preferably, the transmitting terminal 20 may set whether or not information data is to be combined into the electronic mail. The setting may be set, in advance, on the server 21 by the transmitting terminal 20. Preferably, the transmitting terminal may set the setting on the electronic mail itself to be transmitted to the server 21. Furthermore, the transmitting terminal 20 may set a keyword to be extracted to search for the information data. For example, the transmitting terminal 20 may set the keyword or the certain field where the keyword belongs to, on the server 21 in advance, or on the header information, the main text data of the electronic mail to be transmitted, and so on.

FIG. 2 shows a configuration of the sever 21 in FIG. 1. As shown in FIG. 2, the server 21 comprises a recognition circuit 30, a processing circuit 32 and, preferably, a memory 31.

The recognition circuit 30 receives the electronic mail from the transmitting terminal 20. In addition, the recognition circuit 30 provides the electronic mail for the processing circuit 32. Preferably, the recognition circuit 30 may extract a keyword from the text of the electronic mail and provide the keyword for the processing circuit 32. Preferably, the recognition circuit 30 may extract the keyword according to the setting indicating the keyword to be extracted or the field where the keyword is used. Instead of the main text of the electronic mail, the recognition circuit 30 further may recognize and extracts a keyword from a title, a header information, a transmission source address, a transmission destination address or an attached file of the electronic mail. Further preferably, the recognition circuit 30 may store the memory 31 with the keyword thus extracted into.

The processing circuit 32 receives the electronic mail, and preferably the keyword, from the recognition circuit 30. The processing circuit 32 combines information data relating to the electronic mail with the electronic mail, if the setting indicates that information data is to be combined into the electronic mail. The information data relating to the electronic mail may be retrieved from the memory 31 or the network 22. Preferably, the processing circuit 32 may search the memory 31 or the network 22, by the keyword extracted by the recognition circuit 30, in order to retrieve the information data relating to the electronic mail. Further preferably the processing circuit 32 may store the memory 31 with the information data, preferably related to the keyword, retrieved from the network 22, wherein the processing circuit 32 may retrieve information data from the data stored in the memory 31 which is previously retrieved from the network 22. In addition, the processing circuit transmits the electronic mail combined with the information data to the receiving terminal 23.

If the setting does not indicate that information data is to be combined into the electronic mail, the processing circuit 32 transmits the electronic mail to the receiving terminal 23, without combining information data relating to the electronic mail with the electronic mail.

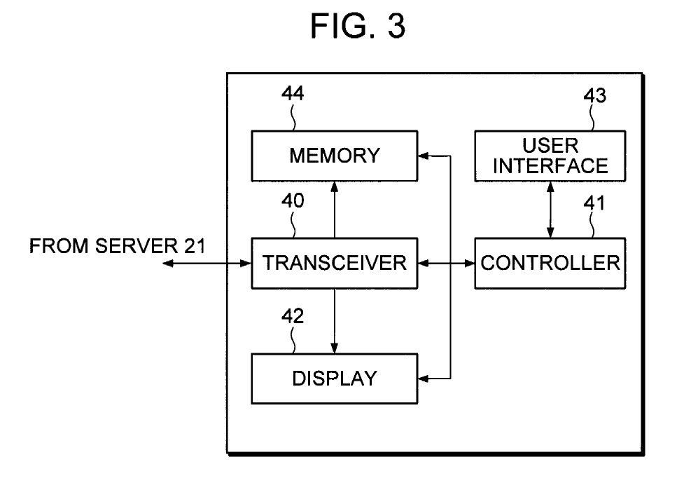

FIG. 3 shows a configuration of the receiving terminal 23 in FIG. 1. As shown in FIG. 3, the receiving terminal 23 comprises a transceiver 40, a control circuit 41, a display 42, an user interface 43, and a memory 44.

The transceiver 40 receives, from the sever 21, the electronic mail itself and/or the information data combined, and provides the received electronic mail and/or the information data combined for the memory 44. Preferably, the transceiver 40 may provide the received electronic mail and/or the information data combined for the display 42.

The memory 44 may store the electronic mail provided by the transceiver 40.

The control circuit 41 controls the transceiver 40, the display 42, the user interface 43, and the memory 44. Preferably the control circuit 41 may set a setting indicating whether information data is to be combined into the electronic mail. The setting may be set, in advance, on the server 21 by the control circuit 41 via the transceiver 40.

The display 42 retrieves the electronic mail and/or the information data combined from the memory 44. Preferably, the display 42 may be provided with the electronic mail and/or the information data combined by the transceiver 40. The display 42 displays the electronic mail itself, if the information data is not combined with the electronic mail. In addition, the display 42 displays the information data combined and/or an item of the information data together with the electronic mail itself, if the information data is combined with the electronic mail. Preferably, the display 42 displays details or contents of the information data or the item of the information data which is selected by the control circuit 41. Preferably, the information data to be displayed in detail may be selected by a user via the user interface 43. Further preferably, the details or contents of the information data may be retrieved from outside of the receiving terminal 23, for example, the network 22 or the sever 21, via the transceiver 40, or be retrieved from the memory 44.

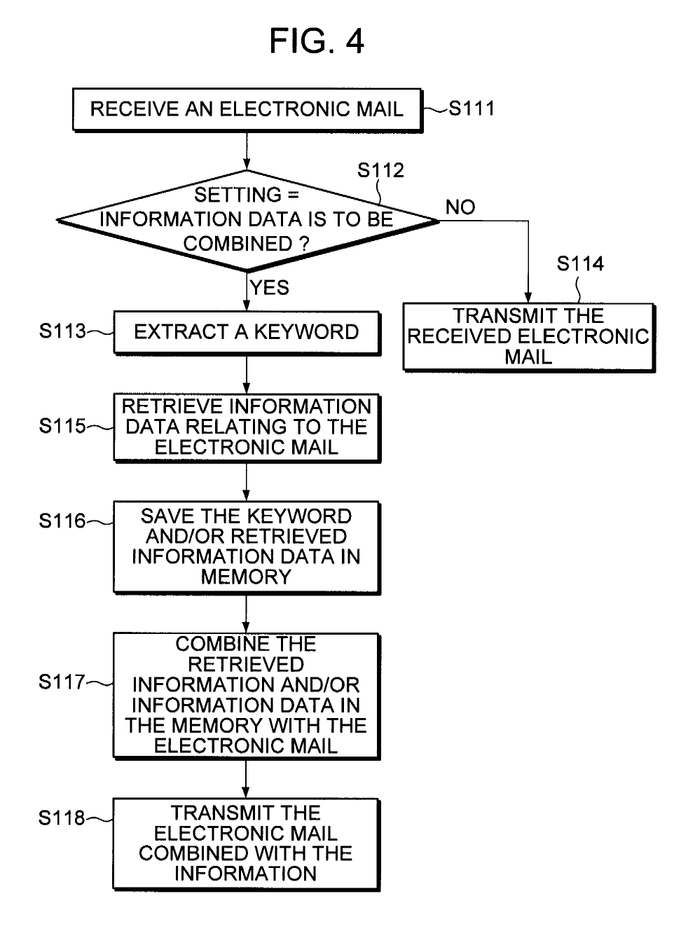

FIG. 4 is a flowchart showing an operation of the server 21 in the first embodiment of the electronic mail transmitting and receiving system according to the present invention. Referring to FIG. 4, the operation of the server 21 will be explained.

The recognition circuit 30 receives an electronic mail by cable or by radio, from the transmitting terminal 20 (Step S111). The processing circuit 32 in the server 21 checks a setting whether or not the information data is to be combined into the electronic mail (Step S112). This setting may be set, in advance, by the transmitting terminal 20 or the receiving terminal 21. Furthermore, the electronic mail itself thus received may contain this setting.

If the setting does not indicate that the information data is to be combined into the electronic mail, the processing circuit 32 transmits the electronic mail thus received to the receiving terminal 23.

If the setting indicates that the information data is to be combined into the electronic mail, the recognition circuit 30 extracts a keyword from the electronic mail (Step S113). The processing circuit 32 searches the network 22 or the memory 31 for the information data relating to the extracted keyword, and retrieves the information data. Preferably the processing circuit 32 may search the memory at first. If the data relating to the electronic mail is not found in the memory 31, the processing circuit 32 may search the network 22 (Step S115). Furthermore, the processing circuit 32 stores the memory 31 with the information data and/or the keyword thus extracted (Step S116). The processing circuit 32 combines the retrieved information data with the electronic mail, and transmits the electronic mail with the information data to the receiving terminal 23 by cable or by radio (Steps S117, S118).

Here, it is possible for the server 21 to skip the step S113. In this case, the processing circuit 32 retrieves the information data such as a fixed or predetermined data from the network 22 or the memory 33. Then, the processing circuit 32 combines the information data thus retrieved with the electronic mail, and transmits it to the receiving terminal 23 (Steps S117, S118). In addition, it is also possible for the server 21 to skip the step S116. Furthermore, it is also possible for the server 21 to skip both steps of S113 and S116.

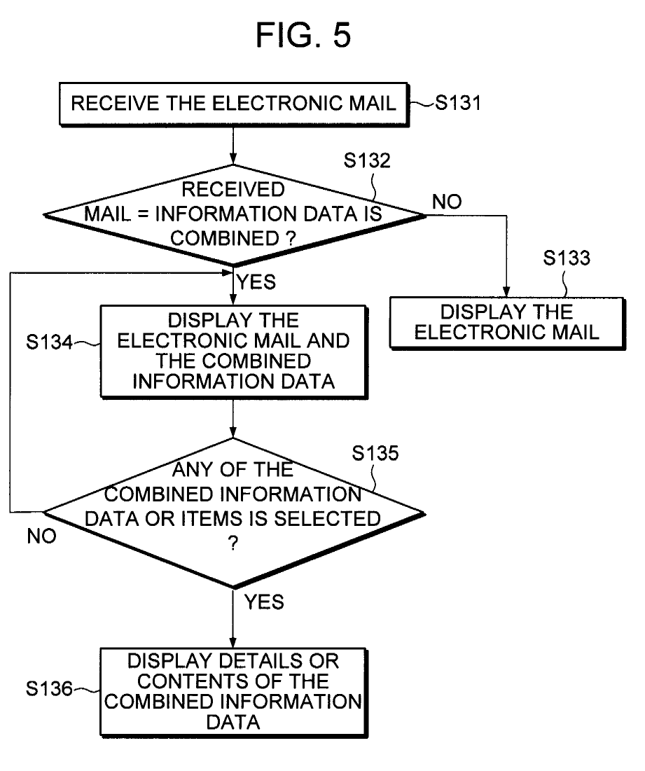

FIG. 5 is a flowchart showing an operation of the receiving terminal 23 in the first embodiment of the electronic mail transmitting and receiving system according to the present invention. Referring to FIG. 5, the operation of the receiving terminal 23 will be explained.

The transceiver 40 receives an electronic mail from the server 21 (Step S131). The control circuit 41 checks whether or not the electronic mail thus received is combined with information data (Step S132). If the information data is not combined with the electronic mail thus received, the display 42 displays the received electronic mail itself (Step S133). If the information data is combined with the electronic mail thus received, the display 16 displays the received electronic mail together with the combined information data and/or an item of the information data (Step S134). When the information data combined or the item of the information data is selected by the control circuit 41, preferably by a user via the user interface 43, the display 42 displays details or contents of the information data (Step S136).

Preferably, the server 21 may transmit an item list of the information data relating to the electronic mail transmitted from the transmitting terminal 20. In this case, referring to FIG. 1 and FIG. 2, the processing circuit 32 searches the network 22 or the memory 31 for the information data relating to the electronic mail, makes the item list of the information data relating to the electronic mail, and transmits the item list and the electronic mail to the receiving terminal 23. Furthermore, the processing circuit 32 transmits information data associated with an item selected by the receiving terminal 23, according to a request transmitted from the receiving terminal 23. The operation of the recognition circuit is identical with that shown in FIG. 4.

At the receiving terminal, referring to FIG. 3, the transceiver 40 receives the item list and the electronic mail from the server 21. Furthermore, the transceiver stores the memory 44 with the item list and the electronic mail. The display 42 displays the item list and the electronic mail. The controller selects at least one item from the item list displayed on the display 42. A user may select the item via user interface 43 and control circuit 41. According to the selection, the controller transmits, to the server 21 or the network 22, the request for the information data associated with the item selected. Furthermore, the transceiver 40 receives the information data transmitted, according to the request, from the sever 21, and store the memory with the information data received. In addition, the display 42 displays the received information data associated with the item selected. It is possible for the transceiver 40 to provide the display 42 with the index, information data, or the electronic mail.

The processing circuit 22 may transmit the electronic mail, preferably with the information data, to the receiving terminal 23 after the transmission of the index list or the reception of the request. Further mote, the processing circuit 22 may transmit the electronic mail, to the receiving terminal 23, before the transmission of the index list.

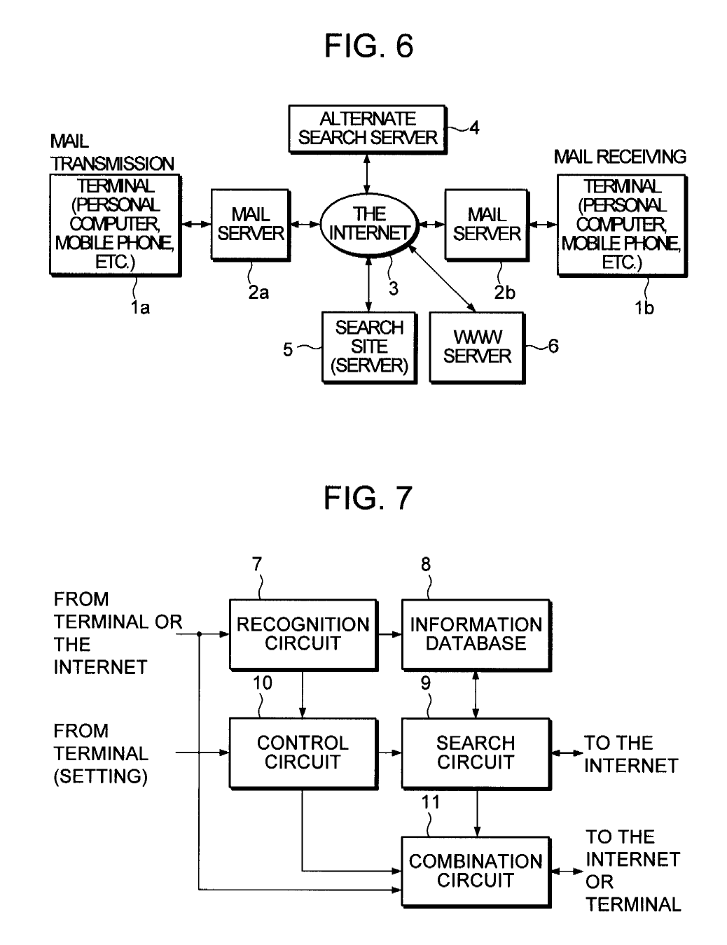

FIG. 6 is a configuration diagram showing a second embodiment of the electronic mail transmitting and receiving system according to the present invention.

As shown in FIG. 6, the electronic mail transmitting and receiving system according to the present invention comprises terminals 1a, 1b, mail servers 2a, 2b, the Internet 3, an alternate search server 4, a search site 5, and a WWW server 6. Here, any one or, any combination of two or three of the Internet 3, the alternate search server 4, and the search site 5 may be applied to the first embodiment as the network 22.

As shown in FIG. 6, the terminals 1a and 1b are user terminals. Though two terminals 1a and 1b are shown in the figure, the number of the terminals is not limited to two in practice, and a plurality of user terminals are connected respectively with the mail servers. For ease of explanation, it is assumed that the terminal 1a is at a transmitting side, and the terminal 1b is at a receiving side. Similarly, the mail server 1a is assumed as a transmitting mail server, and the mail server 1b is assumed as a receiving mail server. Furthermore, it is also possible for the transmitting terminal 1a to transmit an electronic mail to a plurality of receiving terminals 1b. On the other hand, there may be a configuration that the terminal 1b serves as a transmitting terminal and the mail server 2b serves as a transmitting mail server, and the terminal 1a serves as a receiving terminal and the mail server 2a serves as a receiving mail server.

In FIG. 6, the transmitting terminal 1a has a function to transmit an electronic mail, to the user terminal 1b, by way of the mail server 2a, the Internet 3, and the mail server 2b. Here, the transmitting terminal 1a may be applied to the first embodiment as the transmitting terminal 20.

FIG. 9 is a block diagram showing a configuration of the terminal 1a, which is the transmitting terminal as shown in FIG. 6. The transmitting terminal 1a used in the present invention can be any terminal which is capable of transmitting an electronic mail, including a personal computer, mobile phone, PHS (Personal Handy-Phone System), PDA (Personal Digital Assistants) and the like.

As shown in FIG. 9, the terminal 1a comprises an antenna 12, a transceiver 13, a control circuit 14, a speaker 15, a display 16, a memory 17, and, a user interface 18.

The transceiver 13 transmits via the antenna 12, an electronic mail to the mail server 2a.

The control circuit 14 controls the transceiver 13, the speaker 15, the display 18, the memory 17, and the user interface 18. In addition, the control circuit 14 may set a setting, indicating whether the information data relating to the electronic mail is to be combined with the electronic mail, on the mail server 2a. Furthermore, the control circuit may set the setting on the electronic mail to be transmitted itself, for example on the header information, the text data of the electronic mail to be transmitted, and so on. Furthermore, the control circuit 14 may set a keyword to be extracted to search for the information data. For example, the control circuit 14 may set the keyword or the certain field where the keyword belongs to, on the transmitting mail server 2a in advance, or on the header information, the text data of the electronic mail to be transmitted, and so on.

The speaker 15 generates a voice of phone, and notifies a user of incoming call and the like. The memory 17 stores the electronic mail transmitted or to be transmitted and other information. The display 16 displays the electronic mail transmitted or to be transmitted, and other information retrieved from the memory 17. Via the user interface 18, a user may manipulate (for example, make, select, and transmit) the electronic mail transmitted or to be transmitted. In addition, the user may make the setting explained above via the user interface 18.

Returning to FIG. 6, the mail servers 2a and 2b carry out transmitting and receiving of an electronic mail from the user terminal 1a. The mail servers 2a and 2b further conduct a search of information data relating to the electronic mail. Each of the mail servers 2a and 2b is provided with a database for managing the information data, and carries out a processing for combining the electronic mail and the related information data. Here, the mail server 2a and 2b can be applied to the first embodiment as the sever 21.

FIG. 7 is a block diagram showing a configuration of the mail server 2a or 2b as shown in FIG. 6. As shown in FIG. 7, the mail server 2a or 2b comprises a recognition circuit 7, an information database 8, a search circuit 9, a control circuit 10, and a combination circuit 11. Here, the combination of the search circuit 9, the control circuit 10, and combination circuit 11 can be applied to the first embodiment as the processing circuit 32. In addition, the information database 8 may be applied to the first embodiment as the memory 31.

The recognition circuit 7 receives an electronic mail from the transmitting terminal 1a, and recognizes and extracts a keyword from a main text of the electronic mail. The recognition circuit 7 may further recognize and extract a keyword from the title, header information, transmission source address, transmission destination address or an attached file of the electronic mail, in stead of the main text of the electronic mail. When the text of the electronic mail is written in English, the recognition circuit 7 may have a function to translate it into Japanese, and when the attached file includes voice data, the recognition circuit 7 may have a function to convert the voice data into characters. It is further possible to specify in advance a keyword to be extracted. The keyword to be extracted or the field where the keyword belongs to may be set by the transmitting terminal 1a or the receiving terminal 1b, in advance. Furthermore, the keyword to be extracted or the field where the keyword belongs to may be set on the main text, header information, a title of the electronic mail, and so on. The recognition circuit 7 may store the keyword thus extracted into the information database 8.

The search circuit 9 searches for information data relating to thus extracted keyword, and retrieve the information data such as data stored in the information database 8 explained later. In the present case, the search circuit 9 accesses the search site 5 via the Internet 3, and retrieves the information data. Here, the search site 5 can be connected directly with the mail servers 2a and 2b without going through the Internet 3. It is further possible to provide the mail servers 2a and 2b themselves with a function similar to the function of the search site 5. In addition, the search circuit 9 may search the information database 8 for information data relating to thus extracted keyword, and retrieve the information data from the information database 8. The search circuit 9 may narrow down the information data to be retrieved, using the keyword by a search formula AND or OR if required, and may search for the information data relating to the electronic mail.

If the function of a keyword search conducted by a specialist is activated, the search circuit 9 transmits the electronic mail to the alternate search server 4 via the Internet 3. The search circuit 9 retrieves from the alternate search server 4 the information data as a result of the search. The search conducted by the alternate search server 4 includes a search similar to the search conducted by the search circuit 9 by way of accessing the search site 5.

In addition, the search circuit 9 stores thus retrieved information data into the information data base 8. The search circuit 9 may further provide thus retrieved information data, from Internet 3 or the information database 8, for the combination circuit 11.

The control circuit 10 controls narrowing down of the information data to be retrieved by the keyword in the search circuit 9. The control circuit 10 may retrieve the information data from the information database 8, in stead of the search circuit 7, and provide the combination circuit 11 with the information data retrieved. The control circuit 10 further controls, preferably according to the setting, whether or not the combining circuit 11 is to combine the information data retrieved, by the control circuit 10, from the information database 8 and/or the information data retrieved by the search circuit 9, with an electronic mail. Preferably, at the receiving mail server 2b, if the setting does not indicate the information data is to be combined with the electronic mail, the control circuit 10 may transmit the electronic mail itself without combined information data, even though the information data has been combined with the electronic mail at the transmitting mail server 2a.

The combination circuit 11 may combine the information data provided by the control circuit 10 and/or the information data provided by the search circuit 9 with the electronic mail from the transmitting terminal 1a, and transmit thus combined electronic mail to the receiving terminal 1b. Here, the term “combination” means that to add or attach information data to electronic mail.

Preferably, each of the mail servers 2a and 2b may manage and store information data to be into an electronic mail, in the information database 8, with respect to each of the multiple user terminals.

Further preferably, the processing above may be carried out not only in the transmitting mail server 2a, but also in the receiving mail server 2b. Therefore, even if the transmitting terminal 1a sets, on the transmitting mail server 2a, the setting not indicating that the information data is to be combined with the electronic mail, the information data may be combined with the electronic mail at the receiving mail server 2b according to a setting made by the receiving terminal 1b. Conversely, at the receiving mail server 2b, if the setting does not indicate the information data is to be combined with the electronic mail, the receiving mail server 2b may transmit the electronic mail itself without combined information data, even though the information data has been combined with the electronic mail at the transmitting mail server 2a.

Further preferably, the mail server 2a or 2b may transmit, to the transmitting terminal 1a, the information data relating to the electronic mail, which is transmitted to the receiving terminal 1b. The transmitting terminal 1a may input in the field of “cc (carbon copy)”, a mail address of the transmitting terminal 1a (the mail address of its own) when it transmits an electronic mail to the receiving terminal 1b, and then the transmitting terminal 1a is capable of obtaining the information data relating to the electronic mail, which is transmitted to the receiving terminal 1b by the mail server 2a or 2b.

The information database 8 stores the information data. In addition, the information database 8 stores extracted keyword. The information data stored in the information database 8 my be the data, retrieved from the Internet 3 and stored by the search circuit 9 or stored in advance. The keywords stored in the information data base 9 may be the keywords, extracted and stored by the recognition circuit 7 or stored in advance.

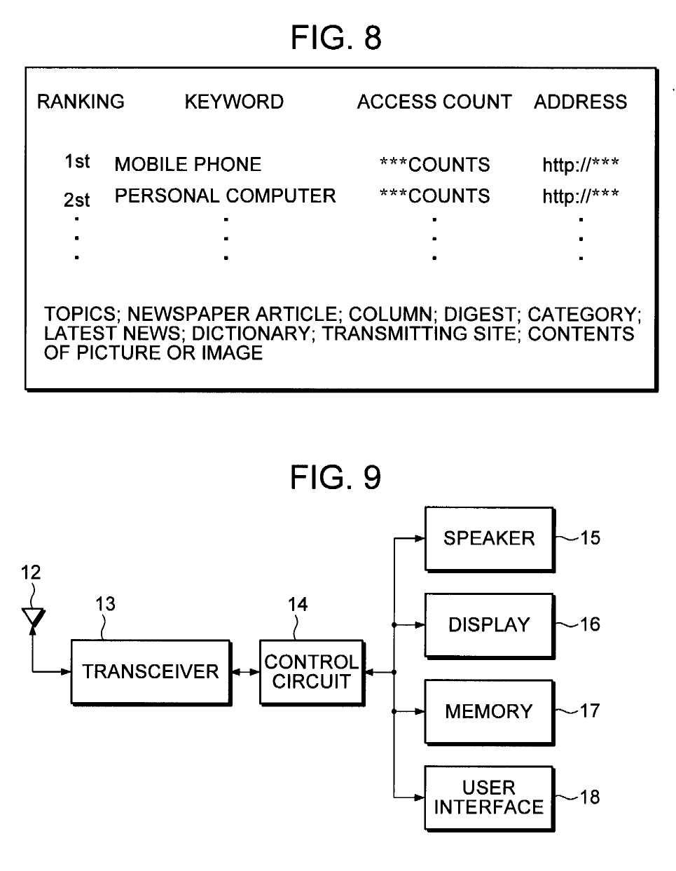

FIG. 8 shows an example of the information database 8. The information database 8 comprises information data tables which contain information data associated with keywords. Furthermore, the information data are associated with access counts, and lined up according to the access count (From top to bottom, the access count of the information data goes from large number to small number). Here, the access count means how many times the keyword has been extracted from the electronic mail. An example of the information data tables, which showed in FIG. 8, contains URLs or network addresses (may be expressed by file names) which are lined up as information data associated with the keywords. URL or the network address is an example of a location of contents or details of information in the Internet 3, the information database 8 itself, the memory 17 in the receiving terminal 1b, and so on. The contents or the details may be HTML files, text data, movie data, image data, and so on.

Furthermore, the information database 8 may contains various tables which line up information data, associated with keywords, such as topics, article, editorial, latest news, columns, category, transmitting or receiving site, picture data, image data, dictionary, and so on.

The dictionary table includes various dictionaries, preferably associated with the keywords, such as Japanese-Japanese dictionary, thesaurus, English-Japanese dictionary, Japanese-English dictionary, and the like.

The transmitting site means the site where the transmitting terminal 1b transmits the electronic mail, and the receiving site means the site where the receiving terminal 1b receives the electronic mail. The transmitting or receiving site as the information data may include data, preferably associated with the keywords, such as a location (for example, the latitude and longitude and the like based on the GPS (Global Positioning System)), address, phone number, a name of facility near the site (for example, a bank, shop, or station) and the like.

As explained above, the search circuit may retrieve the information data from the information database 8, the mail server 2a or 2b is, therefore, capable of transmitting those data (location of contents or contents themselves) included in various information data tables as the information data relating to the electronic mail.

Preferably, the mail server 2a or 2b may automatically transfer to the receiving terminal 1b or transmitting terminal 1a, the information data associated with the keywords with large number of count or the keyword with large number of count themselves, on a regular schedule (every day, every week, every month, or every year).

Returning to FIG. 6, at the alternate search server 4, upon receipt of a text in the electronic mail which is transmitted from the mail servers 2a, 2b via the Internet 3, a specialist carries out a surrogate search by a keyword extracted from the electronic mail. The alternate search server 4 transmits a result of the search to the mail servers 2a, 2b via the Internet 3. It is preferable that the alternate search server is capable of charging the transmitting terminal 1a or the receiving terminal 1b for the cost of the search. Since it is a search by a specialist, a search result with high precision can be expected.

In the alternate search by a keyword conducted by a specialist at the alternate search sever 4, it is possible to restrict the personnel since a high level of security is to be retained. There is also an option for the user not to use the alternate search server 4.

In FIG. 6, the search site 5 is a site (server) functioning as a search engine which searches for information in the Internet 3. For example, the search site 5 may be a site which is usable by the WWW server 6 as a search site. It is to be noted here that the electronic mail transmitting and receiving system according to the second embodiment of the present invention does not necessarily require the WWW server 6.

FIG. 9 is a block diagram showing a configuration of the receiving terminal 1b shown in FIG. 6. The configuration of the receiving terminal 1b is identical with that of transmitting terminal 1a.

The receiving terminal 1b used in the present invention can be any terminal which is capable of receiving an electronic mail, including a personal computer, mobile phone, PHS (Personal Handy-Phone System), PDA (Personal Digital Assistants) and the like.

As shown in FIG. 9, the receiving terminal 1b comprises an antenna 12, a transceiver 13, a control circuit 14, a speaker 15, a display 16, a memory 17, and, a user interface 18. Here, the transceiver 13, the control circuit 14, display 16, and the memory 17 may be applied to the first embodiment as the transceiver 40, the control circuit 41, display 42, and the memory 44 in the first embodiment respectively.

The transceiver 13 receives via the antenna 12, the electronic mail transmitted from the transmitting terminal 1a and/or the information data combined at the transmitting mail server 2a or the receiving mail server 2b, from the receiving mail server 2b. The transceiver 13 stores the memory 17 with the received electronic mail and/or the information data combined. Preferably, the transceiver 13 may provide the received electronic mail and/or the information data combined for the display 16.

The memory 17 stores the received electronic mail and the information data combined.

The speaker 15 generates a voice of phone, and notifies a user of incoming call and the like.

The control circuit 14 controls the transceiver 13, the speaker 15, the display 16, the memory 17, and the user interface 18. Preferably, the control circuit 14 may set a setting, indicating whether the information data relating to the electronic mail is to be combined with the electronic mail, on the receiving mail server 2b. In addition, preferably, the control circuit 14 may set a keyword to be extracted to search for the information data. For example, the control circuit 14 may set the keyword, via transceiver 13 on the receiving mail server 2b in advance. Furthermore, the circuit 14 may select the information data, combined with the electronic mail, displayed on the display 18.

Via user interface 18, a user may manipulate (for example, receive, display, and so on) the electronic mail received. Preferably, a user may select the information data or the item of the information data, combined with the electronic mail and displayed on the display 16 via the user interface 18 and control circuit 14.

The display 16 displays the electronic mail, the information data, the item of the information data and the like retrieved from the memory 17 or provided by the transceiver 13.

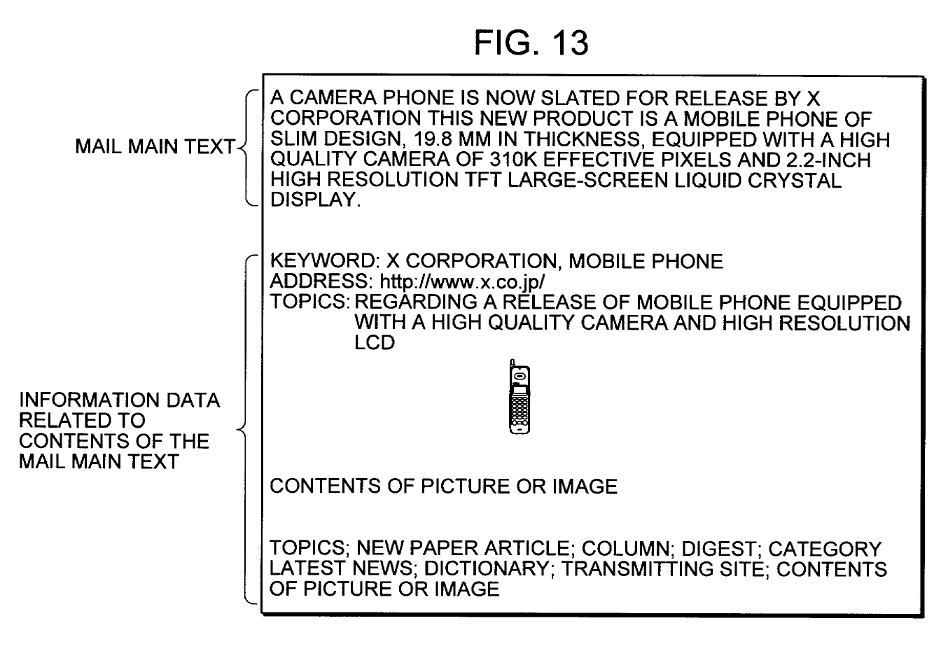

FIG. 13 is an example of a display view on the display 16 of the receiving terminal 1b. As shown in FIG. 13, the receiving terminal 1b is capable of displaying the main text of the electronic mail, preferably the keyword extracted at the mail sever 1a or 1b, the information data, and an item of the information data relating to and combined with the electronic mail, on the display 16 of the receiving terminal 1b. Here, the information data may be same as the information data contained in the information database 8 in the mail server 2a or 2b, such as locations of details or contents of information (URL, network addresses, file name, and so on), topics, article, editorial, latest news, columns, category, transmitting or receiving site information, picture data, image data, dictionary, and so on.

The user may select at least one of the information data or the item of the information data. According to the selection, the contents or the details of the information data relating to the electronic mail is displayed. As a result, the user may retrieve a wider range or details of information data relating to the electronic mail. For example, if the information data, such as a location of details or contents of information, topics, article, editorial, latest news, columns, category, transmitting or receiving site information, picture data, image data, or dictionary is selected, a details or contents, such as HTML files, text data, movie data, image data, maps and the like, may be displayed on the display 16. Furthermore, if the item of the information data is selected, the details or contents of the information data associated with the item selected may be displayed on the display 16.

The details or contents to be displayed may be retrieved from outside of the receiving terminal 1b, such as the internet 3, the mail server 2a and 2b, or inside of the receiving terminal 1b, such as the memory 17.

The user may select the item or information data, for example, by clicking on that displayed via the user interface 18.

At least one or plural items or information data, which appear to be highly relating to the electronic mail, are displayed on the display 16 of the receiving terminal 1b. Here, the information data with a large number of counts in is evaluated as highly related. If there is a large amount of related information data, the number of the counts is also displayed together with the keyword. In addition, by allowing the memory 17 of the user terminal to store the information data combined with the electronic mail, the user may retrieve necessary information immediately, thereby enhancing usage efficiency.

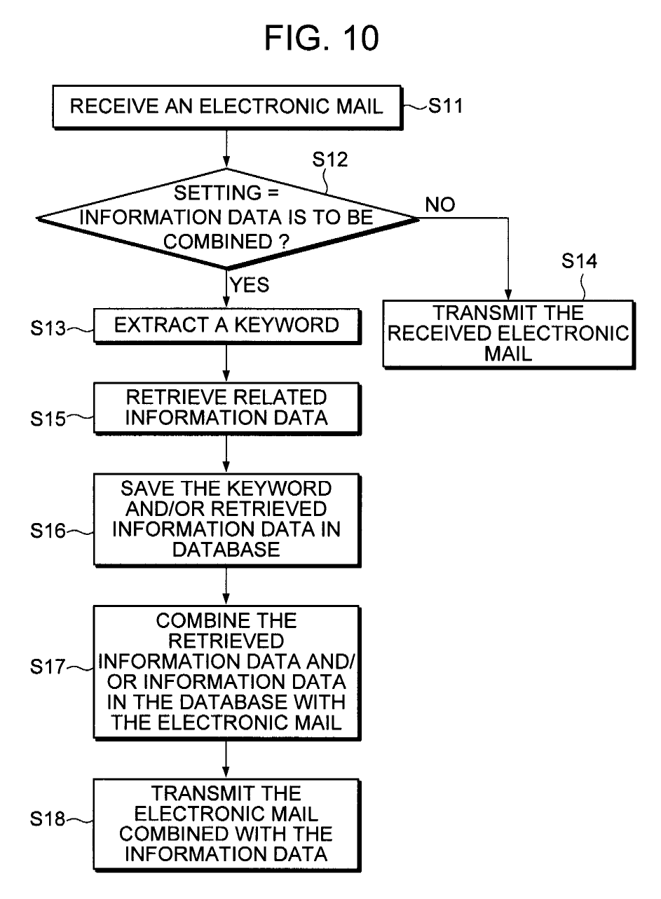

FIG. 10 is a flowchart showing an operation of the transmitting mail server 2a in the second embodiment of the electronic mail transmitting and receiving system according to the present invention. Referring to FIG. 10, the operation of the transmitting mail server 2a will be explained.

The recognition circuit 7 receives an electronic mail by cable or by radio, from the transmitting terminal 1a (Step S11). The control circuit 10 in the transmitting mail server 2a checks a setting whether or not the information data is to be combined into the electronic mail (Step S12). This setting is made in advance by the transmitting terminal 1a. Furthermore, the electronic mail itself thus received may contain this setting.

If the setting does not indicate that the information data is to be combined with the electronic mail, the control circuit 10 transmits the electronic mail thus received to the receiving mail server 2b via the combination circuit 11.

If the setting indicates that the information data is to be combined with the electronic mail, the recognition circuit 7 recognizes and extracts a keyword from the electronic mail (Step S13).

The search circuit 9 accesses the search site (server) 5 or the alternate search server 4, searches for the information data relating to the extracted keyword, and retrieves the information data. In addition, the search circuit 9 may utilize a function similar to the search site 5, provided within the transmitting mail server 2a so as to search for and retrieve the information data without accessing the search cite (server) 5 and the alternate search sever 4. Furthermore, the search circuit 9 may search the information database 8 by the extracted keyword, and retrieve the information data from the information database 8. Preferably, search circuit 9 may search the information data base 8 at first. If the data relating to the electronic mail is not found in the information database 8, the processing circuit 32 may search the both or one of the search site 5 and the alternate search server, or utilize the function similar to the search site 5 provided within the receiving mail server 2b, in order to retrieve the information data (Steps S12).

The search circuit 9 stores the information database 8 (Step S16) with the information data retrieved and the keyword thus extracted. The combination circuit 11 combines the retrieved information data with the electronic mail, and transmits the electronic mail with the information data to the receiving mail server 2b (Steps S17, S18).

Here, it is possible for the transmitting mail server 2a to skip the step S13. In this case, the control circuit 10 retrieves the information data such as a fixed or predetermined data. Then, the combination circuit 9 combines the information data thus retrieved with the electronic mail, and transmits it to the receiving mail server 2b (Steps S17, S18). In addition, it is also possible for the transmitting mail server 2a to skip the step S16. Furthermore, it is possible for the transmitting mail sever 2a to skip the both steps of S13 and S16.

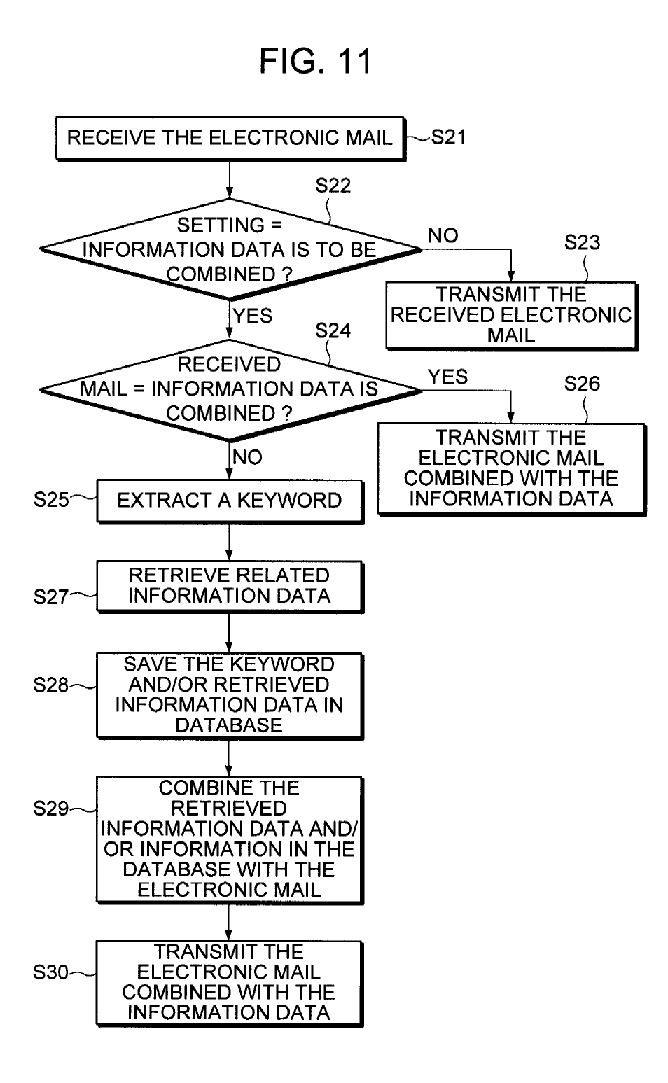

FIG. 11 is a flowchart showing an operation of the receiving mail server 2b in the second embodiment of the electronic mail transmitting and receiving system according to the present invention. Referring to FIG. 11, the operation of the receiving mail server 2b will be explained.

The recognition circuit 7 receives the electronic mail from the transmitting mail server 2a (Step S21). The control circuit 10 checks a setting whether or not the information data is to be combined into the electronic mail (Step S22). This setting is made in advance by the transmitting terminal 1a. Furthermore, the electronic mail itself thus received may contain this setting.

If the setting does not indicate that the information data is to be combined into the electronic mail, the control circuit 10 transmits the electronic mail thus received to the receiving terminal 1b via the combination circuit 11.

If the setting indicates that the information data is to be combined into the electronic mail, the control circuit 10 confirms whether or not the information data is combined with the electronic mail thus received (Step S24).

If the information data is combined with the received electronic mail, the control circuit 10 transmits the electronic mail combined with the information data to the receiving terminal 1b (Step S26).

If the information data is not combined with the received electronic mail, the recognition circuit 7 recognizes and extracts a keyword from the electronic mail received (Step S25).

The search circuit 9 accesses the search site (server) 5 or the alternate search server 4, searches for the information data relating to the extracted keyword, and retrieves the information data. In addition, the search circuit 9 may utilize a function similar to the search site 5, provided within the receiving mail server 2b so as to search for and retrieve the information data with out accessing the search cite (server) 5 and the alternate search sever 4. Furthermore, the search circuit 9 may search the information database 8 by the extracted keyword, and retrieve the information data from the information database 8. Preferably, search circuit 9 may search the information data base 8 at first. If the data relating to the electronic mail is not found in the information database 8, the processing circuit 32 may search the both or one of the search site 5 and the alternate search server, or utilize the function similar to the search site 5 provided within the receiving mail server 2b(S27).

The search circuit 9 stores the information data retrieved and the keyword thus extracted with the information database 8 (Step S28). The combination circuit 11 combines the retrieved information data with the electronic mail, and transmits the electronic mail combined with the information data to the receiving terminal 1b (Steps S29, S30).

Here, it is possible for the receiving mail server 2b to skip the step S25. In this case, the control circuit 10 retrieves the information data such as a fixed or predetermined data. Then, the combination circuit 9 combines the information data thus retrieved with the electronic mail, and transmits it to the receiving terminal 1b (Steps S29, S30). In addition, it is possible for the receiving mail server 2b to skip the steps S28. Furthermore, it is possible for the receiving mail server 2b to skip the both steps of S25 and S28.

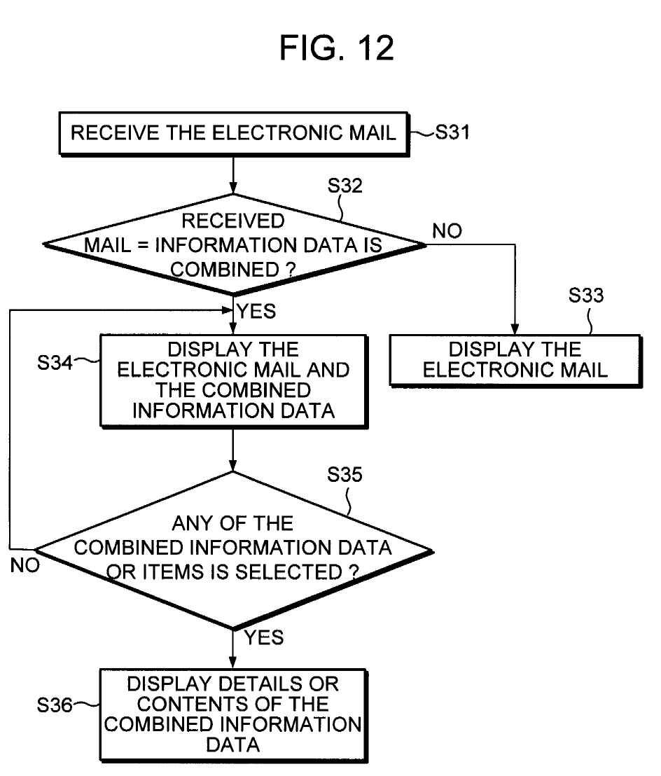

FIG. 12 is a flowchart showing an operation of the receiving terminal 1b in the second embodiment of the electronic mail transmitting and receiving system according to the present invention. Referring to FIG. 12, the operation of the receiving terminal 1b will be explained.

The transceiver 13 receives an electronic mail from the receiving mail server 2b (Step S31). The control circuit 14 checks whether or not the electronic mail thus received is combined with information data (Step S32). If the information data is not combined with the electronic mail thus received, the display 16 displays the received electronic mail. If the information data is combined with the electronic mail thus received, the display 16 displays the received electronic mail together with the combined information and/or an item of the combined information data (Step S34). Preferably, the control circuit 14 may set, in advance, the setting indicating whether the information data is to be combined with the electronic mail on the receiving server 2b via the transceiver 13.

As thus described, the receiving terminal 1b may set the setting on the receiving server 2b. In addition, the receiving mail server 2b carries out a combination processing similar to that of the transmitting mail server 2a, according to the setting set by the receiving terminal 1b. Therefore, even if the transmitting terminal 1a set, on the transmitting mail server 2a, the setting indicating that the information data is not to be combined with the electronic mail, the receiving terminal 1b is capable of obtaining the electronic mail transmitted from the transmitting terminal 1a, together with the information data relating to the electronic mail. Conversely, the receiving terminal may obtain the electronic mail itself without combined information data, even if the transmitting terminal 1a transmitting terminal 1a set, on the transmitting mail server 2a, the setting indicating that the information data is to be combined with the electronic mail.

When the user selects the combined information data or the item of combined information data via the user interface, the display 16 displays details or contents of the information data (Step S36).

As described above, in the electronic mail transmitting and receiving system according to the present invention, the receiving terminal can display the electronic mail itself together with the information data relating to the electronic mail. Furthermore, the electronic mail transmitting and receiving system according to the present invention may be applied to various electronic mail services such as Multimedia Message Service (MMS), Short Message Service (SMS), Enhanced Messaging Service (EMS), E-mail service, and so on.

It will be obvious to those having skill in the art that many changes may be made in the above-described details of the preferred embodiments of the present invention. The scope of the present invention should be determined by the following claims.

What is claimed is:

1. A receiving terminal, in an electronic mail system which comprises a network, a server, and a transmitting terminal, comprising:
a transceiver which receives, from the server, an electronic mail that is transmitted from the transmitting terminal and is combined, at the server, with a specific data relating to the electronic mail;
a memory, coupled to said transceiver, stores the electronic mail combined with the specific data relating to the electronic mail; and
a display, coupled to said memory, which displays at least one of the specific data relating to the electronic mail and an item of the specific data relating to the electronic mail together with the electronic mail.

2. A receiving terminal according to claim 1, wherein the specific data relating to the electronic mail is retrieved, at the sever, from the network.

3. A receiving terminal according to claim 1, wherein the specific data relating to the electronic mail is retrieved, at the sever, from the network by means of a search by a keyword extracted from the electronic mail.

4. A receiving terminal according to claim 1, further comprising
a control circuit which sets, on the sever, a setting indicating whether the specific data relating to the electronic mail is to be combined with the electronic mail.

5. A receiving terminal according to claim 1, wherein said display displays at least one of details or contents of the specific data relating to the electronic mail if said control circuit selects the at least one of the specific data relating to the electronic mail and the item of the specific data relating to the electronic mail displayed by said display.

6. A receiving terminal according to claim 5, wherein the specific data relating to the electronic mail is one of a location of details or contents of information, a topic, an article, an editorial, a latest news, a column, a category, a transmitting or receiving site information, a text data, a picture data, an image data, and a dictionary.

7. A receiving terminal according to claim 6, wherein the details or the contents of the specific data relating to the electronic mail is one of HTML file, a text data, a movie data, an image data, and a map.

8. An electronic mail system comprising:
a transmitting terminal which transmits an electronic mail;
a server which receives the electronic mail from the transmitting terminal, retrieves a specific data relating to the electronic mail from at least one of a network coupled to the sever and an internal memory of the sever, combines the specific data relating to the electronic mail with the electronic mail, and transmits the electronic mail combined with the specific data relating to the electronic mail; and
a receiving terminal which receives the electronic mail combined with the specific data relating to the electronic mail from the server, and displays at least one of the specific data relating to the electronic mail and an item of the specific data relating to the electronic mail together with the electronic mail.

9. An electronic mail system according to claim 8, wherein said server extracts a keyword from the electronic mail, and retrieves the specific data relating to the electronic mail by searching at least one of the network and the internal memory by the keyword.

10. A server, in an electronic mail system which comprises a network, a transmitting terminal, and a receiving terminal, comprising:
a recognition means for receiving an electronic mail from the transmitting terminal;
a processing means for retrieving a specific data relating to the electronic mail from the network, for combining the specific data relating to the electronic mail with the electronic mail, and for transmitting, to the receiving terminal, the electronic mail combined with the specific data relating to the electronic mail.

11. A receiving terminal, in an electronic mail system which comprises a network, a server, and a transmitting terminal, comprising:
a receiving means for receiving, from the server, an electronic mail that is transmitted from the transmitting terminal and is combined, at the server, with a specific data relating to the electronic mail;
a storing means for storing the electronic mail combined with the specific data relating to the electronic mail; and
a displaying mean for displaying at least one of the specific data relating to the electronic mail and an item of the specific data relating to the electronic mail together with the electronic mail.

12. A controlling method, for an electronic mail system which comprises a server, and a transmitting terminal, comprising:
receiving, from the server, an electronic mail that is transmitted from the transmitting terminal and is combined, at the server, with a specific data relating to the electronic mail;
storing the electronic mail combined with the specific data relating to the electronic mail; and
displaying mean for displaying the specific data relating to the electronic mail together with the electronic mail.

13. A controlling method, for an electronic mail system comprising:
transmitting an electronic mail to the sever at a transmitting terminal;
receiving the electronic mail from the transmitting terminal;
retrieving a specific data relating to the electronic mail from at least one of a network coupled to the sever and a internal memory at the sever;
combining the specific data relating to the electronic mail with the electronic mail;
transmitting the electronic mail combined with the specific data relating to the electronic mail;
receiving the electronic mail combined with the specific data relating to the electronic mail, from the server; and
displaying at least one of the specific data relating to the electronic mail and an item of the specific data relating to the electronic mail together with the electronic mail at a receiving terminal.
